(19) United States
(12) Patent Application Publication
(10) Pub. No.: US 2024/0429037 A1
(43) Pub. Date: Dec. 26, 2024

(54) MASS SPECTROMETER FOR ANALYZING AN ANALYTE SAMPLE

(71) Applicant: Analytik Jena GmbH+Co. KG, Jena (DE)

(72) Inventors: Iouri Kalinitchenko, Jena-Maua (DE); Wolfram Weisheit, Saara (DE); Roland Lehmann, Jena (DE)

(21) Appl. No.: 18/731,545

(22) Filed: Jun. 3, 2024

(30) Foreign Application Priority Data
Jun. 7, 2023 (DE) 10 2023 115 078.2

(51) Int. Cl. H01J 49/06; H01J 49/04; H01J 49/10; H01J 49/24

(52) U.S. Cl. CPC H01J 49/066; H01J 49/0404; H01J 49/105; H01J 49/24

(57) ABSTRACT

A mass spectrometer for analyzing an analyte sample includes: a plasma ion source configured to produce a plasma; an interface arrangement configured to form a plasma flux from the plasma and to direct the plasma flux toward a mass analyzer, wherein the interface arrangement includes a cone and a capillary tube, wherein the cone includes an orifice through which the plasma flux is directed, wherein the capillary tube includes an outlet arranged and configured to introduce the analyte sample into the plasma flux at the orifice or in a plasma expansion zone downstream of the orifice such that the analyte sample is ionized and ions are generated, wherein the outlet is in contact with the plasma flux; the mass analyzer, which is configured to filter and/or separate the generated ions; and a detector configured to detect the generated ions from the analyte sample.

### CROSS-REFERENCE TO THE RELATED APPLICATION

The present application is related to and claims the priority benefit of German Patent Application No. 10 2023 115 078.2, filed Jun. 7, 2023, the entire contents of which are incorporated herein by reference.

### TECHNICAL FIELD

The present disclosure relates to a mass spectrometer for analyzing an analyte sample.

### BACKGROUND

In a mass spectrometer, the molecules or atoms of a sample are first transferred into the gas phase and ionized. For ionization, various methods known from the state of the art are available, such as inductively coupled plasma ionization (ICP) or Microwave plasma or Optical (Laser Induced) plasma which ionizes the sample by means of a plasma. Currently, several different types of inductively coupled plasma mass spectrometers (ICP-MS) are available, as e.g., the quadrupole ICP-MS or time-of-flight ICP-MS.

After ionization, the ions pass through a vacuum interface to a mass analyzer, in which they are filtered and/or separated according to their mass-to-charge ratio (m/z). Different types of interfaces and modes of operation are based, for example, on the application of static or dynamic electric and/or magnetic fields or on different times of flight of different ions. Different types of mass analyzers include single, multiple or hybrid arrangements of analyzers, such as quadrupole, triple-quadrupole, time-of-flight (TOF), ion trap, Orbitrap or magnetic sector. Finally, the separated ions are guided towards a detector which, e.g., is one of a photo-ion multiplier, ion-electron multiplier, Faraday collector, Daly detector, microchannel plate, or a channeltron.

Inductively coupled plasma mass spectrometers (ICP-MS) are, e.g., used for trace element analysis. Conventionally, an ICP-MS analysis involves the complete atomization and subsequent ionization of the test sample by means of a plasma ion source before the resulting elemental ions are quantified by the spectrometer.

ICP-MS systems are less suitable or even unsuitable for the analysis of molecules or organic matter, which are typically investigated by mass spectrometers employing different types of ionization sources, e.g., electrospray-ionization (ESI) or atmospheric pressure chemical ionization (APCI). Such methods are optimized for the ionization of molecules and do not lead to an atomization of those. Other mass spectrometry systems suitable for molecular analysis are e.g., the selected-ion flow-tube mass spectrometer (SIFT-MS) or the proton-transfer-reaction mass spectrometer (PTR-MS).

There is a need for mass spectrometers that are able to investigate atomized matter as well as molecules and/or organic matter.

### SUMMARY

Therefore, it is an object of the present disclosure to provide a mass spectrometer which can analyze both atomized and ionized molecules.

The object is achieved by a mass spectrometer for analyzing an analyte sample, comprising:
a plasma ion source configured to produce a plasma;
an interface arrangement which is configured to form a plasma flux out of the plasma and flow it toward a mass analyzer, wherein the interface arrangement comprises at least one cone and at least one capillary tube, wherein the at least one cone comprises an orifice through which the plasma flux is flowed, wherein the at least one capillary tube comprises an inlet and an outlet and is arranged and configured to introduce the analyte sample into the plasma flux at the orifice or in a plasma expansion zone downstream of the orifice such that the analyte sample is ionized by means of the plasma flux and ions are generated, wherein the outlet is in contact with the plasma flux;
the mass analyzer which is configured to filter and/or separate the generated ions; and
a detector configured to detect the generated ions from the analyte sample.

The analyte sample can be gaseous, liquid or solid. The plasma flux comprises positively charged and excited neutral atoms as well as metastable atoms of the gas from which the plasma is generated. The at least one cone may comprise a circular base but may comprise also a differently shaped base such as a quadratic, polygonal or rectangular base. By introducing the analyte sample into the plasma flux in the region of the orifice, the analyte sample will be ionized instead of atomized by the plasma flux as the density and temperature of the plasma flux will be reduced compared to the region of the plasma ion source. The analyte sample can, e.g., be supplied at the position of the orifice or into a plasma expansion zone behind the orifice. Advantageously, the outlet is arranged within the orifice of the at least one cone. As the outlet of the at least one capillary tube is in contact with the plasma flux, the outlet will be continuously cleaned, e.g., etched, by the plasma flux. This effect enables introducing liquid analyte samples into the plasma flux. Usually, introduction of liquid analyte samples will lead to residues and build-up at the outlet. With the present disclosure, this problem is overcome.

By adding the at least one capillary tube to the mass spectrometer, it is possible to analyze both atomized and ionized molecules. For analysis of atomized molecules, the analyte sample is introduced directly into the plasma ion source, whereas for analysis of ionized molecules the analyte sample is introduced by means of the at least one capillary tube.

In one embodiment of the present disclosure, the capillary tube is arranged in a plane parallel to a plane in which the at least first cone is arranged. The capillary tube can be arranged at an angle to the plasma flux, e.g., at an angle between 40° and 130°, e.g., at a right angle to the plasma flux. Such an arrangement of the capillary tube enhances the cleaning of the outlet by the plasma flux.

In another embodiment, the interface arrangement comprises several capillary tubes. Each capillary tube may be used for the same analyte sample or for different analyte samples. It is also possible to use some capillary tubes for the same analyte sample and other capillary tubes for another analyte sample. For the purpose of the application, several capillary tubes means two or more capillary tubes.

Advantageously, the several capillary tubes are arranged radially adjacent to each other. For example, the several capillary tubes may be arranged in a disk-like manner and/or the several capillary tubes may be arranged such their respective outlets surround the orifice with the capillary tubes running from the orifice outwards. Such arrangements of the several capillary tubes save space.

Another embodiment comprises that the outlet is arranged at a predetermined distance to the plasma ion source and/or the at least one cone such that the analyte sample is ionized with a predetermined density of the plasma flux. The density of the plasma is decreased with increasing distance to the plasma ion source by means of the at least one cone. By adjusting the distance between the outlet and the at least one cone and/or the plasma ion source the analyte sample can be ionized with a predetermined density of the plasma flux. Advantageously, the position of the outlet is adjustable, e.g., the position of the at least one capillary tube and/or the at least one cone (e.g., in an embodiment in which the at least one capillary tube is arranged within the at least one cone) can be adjusted.

In one embodiment, the at least one capillary tube is arranged at least partially within the at least one cone or adjacent to it.

The at least first cone can be a sampler cone, a skimmer cone, or a hyper-skimmer cone. Conventionally, the skimmer cone is arranged downstream of the sampler cone. The hyper-skimmer cone is usually arranged downstream of the skimmer cone. For the purposes of the present disclosure, downstream is intended to refer to a position relative to the path of the plasma flux and/or ion beam.

The at least first cone may be arranged in a vacuum, e.g., in an embodiment in which the plasma ion source produces an atmospheric pressure plasma.

In another embodiment, the at least one cone is arranged adjacent to the plasma ion source. The at least one cone may also be arranged adjacent to another cone.

Advantageously, the mass spectrometer comprises a voltage source configured to apply a positive or negative voltage with respect to a potential of the plasma flux to the at least one cone. The at least one cone is subjected to the positive or negative voltage with respect to a potential of the plasma flux by means of the voltage source. In conventional setups, the at least one cone is grounded, and ions generated by the plasma are propelled forward by the plasma and accelerated by an extraction lens towards a mass analyzer. By applying a positive voltage to the at least one cone, positively charged ions, which are generated by interaction of the analyte sample with the plasma flux, are accelerated towards the mass analyzer, thus increasing the signal intensity of those ions on the detector. Vice versa, applying a negative voltage to the at least one cone leads to an acceleration of negatively charged ions, which are generated by interaction of the analyte sample with the plasma flux, thus increasing their respective signal intensity on the detector. The positive or negative voltage may be applied as DC voltage or as voltage pulses.

The voltage at the at least one cone may be adjusted between 0 to ±200 V with respect to a potential of the plasma flux. The positive voltage may advantageously be selected in the range of 0 to ±20V.

Another embodiment comprises the analyte sample comprises organic, particulate and/or biological matter. The analyte sample may comprise a liquid and cells, virus, bacteria and the like.

In a further embodiment, the at least one capillary tube is connectable to a gas chromatograph or a liquid chromatograph or a biological sample introduction system. The analyte sample, which is prepared by the gas chromatograph or liquid chromatograph or biological sample introduction system, can be directly injected into the mass spectrometer of the present disclosure by means of the at least one capillary tube. The biological sample introduction system is preferably a micro-biological sample introduction system. A micro-biological sample introduction system is specifically configured to handle micro-biological samples such as cells, bacteria and viruses.

In another embodiment, the mass spectrometer comprises two or more detectors. For example, different types of detectors may be chosen. For example, the mass spectrometer may comprise a first detector configured to detect atomized ions and/or molecules and a second detector configured to detect ionized molecules.

In a further embodiment, the mass spectrometer comprises two or more mass analyzers. The mass analyzer may be a quadrupole mass analyzer, a time-of-flight analyzer, a triple-quadrupole mass analyzer, an ion trap, an Orbitrap or a magnetic sector analyzer.

The plasma ion source may be configured to produce a plasma at atmospheric pressure. For example, the plasma ion source may be an inductively coupled plasma torch.

### BRIEF DESCRIPTION OF THE DRAWINGS

In the following, the present disclosure as well as its advantageous embodiments will be explained with reference to FIGS. 1-4 in which:

FIG. 1 illustrates a schematic of a first embodiment of the mass spectrometer according to the present disclosure;

FIG. 2 illustrates a schematic of a second embodiment of the mass spectrometer according to the present disclosure;

FIG. 3 shows a partial section view of a first embodiment of a cone with capillary tubes according to the present disclosure; and

FIG. 4 shows a partial section view of a second embodiment of a cone with capillary tubes.

### DETAILED DESCRIPTION

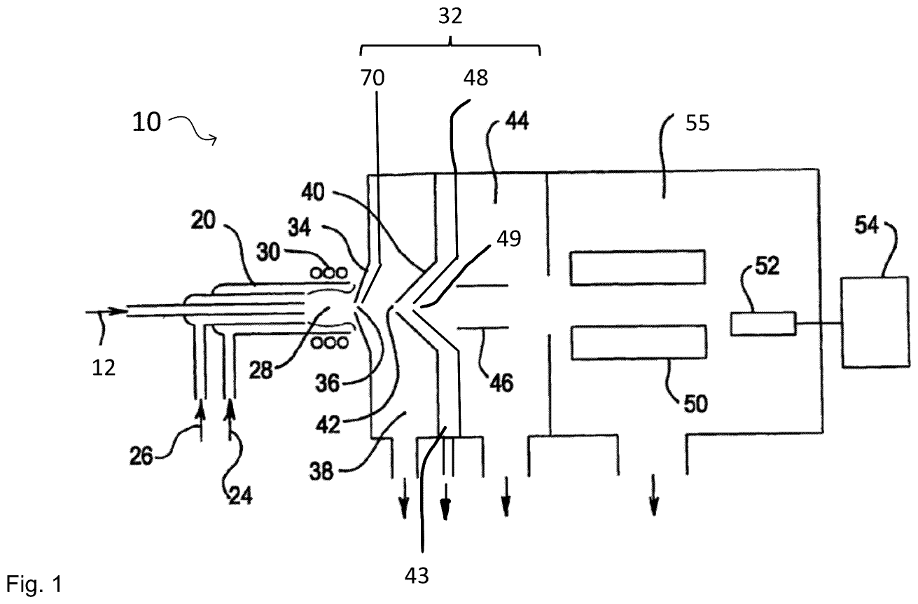

An exemplary mass spectrometer 10 of the present disclosure is shown in FIG. 1. The mass spectrometer 10 comprises a plasma ion source 20 for producing a plasma 28, an interface arrangement 32 for forming a plasma flux 61 from the plasma 28 and for flowing (e.g., directing) the plasma flux 61 towards a mass analyzer 50 and a detector 52. The plasma ion source 20 can be an ICP torch with a radio frequency coil 30. The ICP torch is connected to a plasma forming gas 24 and an auxiliary gas 26 for sustaining the plasma 28.

The interface arrangement 32 comprises at least one cone 60 with an orifice 62 through which the plasma flux 61 is flowed, and at least one capillary tube 70 with an inlet 71 and outlet 72. The at least one cone 60 may be a sampler cone 34, a skimmer cone 40 or a hyper-skimmer cone 48. The at least one capillary tube 70 is arranged and configured to introduce the analyte sample 12 into the plasma flux 61 at the orifice 62 or in the plasma expansion zone 64 of it such that the analyte sample 12 is ionized by means of the plasma flux 61 and ions are generated.

In FIG. 1 the at least one capillary tube 70 is arranged adjacent to the sampler cone 34. However, the at least one capillary tube 70 may also be arranged adjacent or within the sample cone 34, the skimmer cone 40 and/or the hyper-skimmer cone 48. Preferably, the analyte sample 12 is supplied into the orifice 62 of the at least one cone 60. The interface arrangement 32 may comprise several capillary tubes 70. Preferably, the at least one capillary tube 70 is arranged in a plane parallel to a plane in which the at least one cone 60 is arranged. The mass spectrometer 10 further comprises a mass analyzer 50 and a detector 52. Recording means 54 may be connected to detector(s) 52.

The plasma ion source 20 may be configured to produce an atmospheric pressure plasma. The at least one cone 60 may be arranged in vacuum. In the example of FIG. 1, the cones 34, 40 and 48 each have an orifice 36, 42, 49 through which the plasma flux 61 passes from the plasma ion source 20 into a first 38, second 43 and third vacuum region 44. The third vacuum region 44 comprises an extraction lens 46 (e.g., an extraction electrode) which is configured to extract an ion beam from the plasma flux 28 into a fourth vacuum region 55 and towards a mass analyzer 50. Typically, the pressure in the vacuum regions decreases from the first vacuum region 38 to the fourth vacuum region 55. The density and temperature of the plasma flux 61 typically decreases from the orifice 36 of sampler cone 34 to the extraction lens 46. The outlet 72 of the at least one capillary tube 70 may be arranged at a predetermined distance to the plasma ion source 20 and/or the at least one cone 60 such that the analyte sample 12 is ionized with a predetermined density of the plasma flux 28.

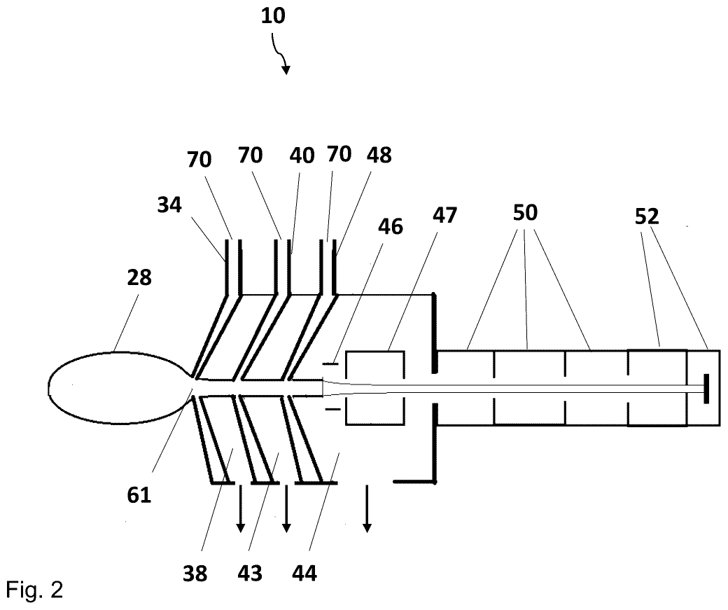

Because the mass spectrometer 10 can analyze both ionized atoms and ionized molecules, in an advantageous embodiment, the mass spectrometer 10 comprises two or more detectors 52 and/or two or more mass analyzers 50. Such an embodiment is shown in FIG. 2.

FIG. 2 also shows an embodiment of the mass spectrometer 10 in which three cones are modified to contain at least one capillary tube 70. The three cones are sample cone 34, skimmer cone 40 and hyper-skimmer cone 48. As apparent to one skilled in the art, also other arrangements of the at least capillary tube 70 are possible. The two or more mass analyzers 50 may be chosen such that each mass analyzer 50 is configured to filter the ions generated from a particular capillary tube 70. For example, the upstream mass analyzer 50 may be adapted to filter the ions which were generated by introduction of the analyte sample 12 at the sampler cone 34. The mass analyzer 50 in the middle may be adapted to filter the ions which were generated by introduction of the analyte sample 12 at the skimmer cone 40. Likewise, the downstream mass analyzer 50 may be adapted to filter the ions which were generated by introduction of the analyte sample 12 at the hyper-skimmer cone 48.

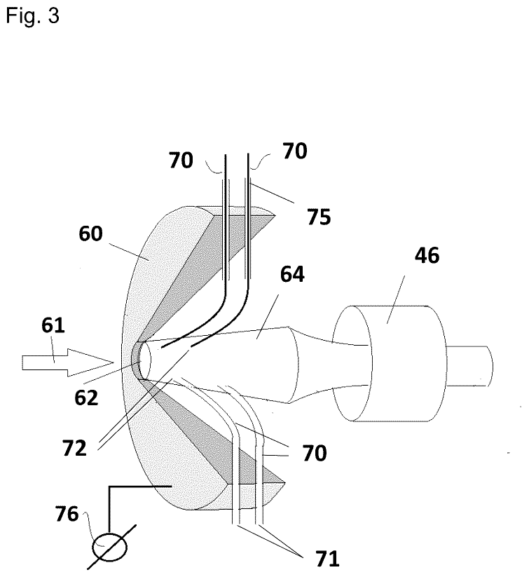

FIG. 3 illustrates a first embodiment of the at least one cone 60. The at least one cone 60 has been modified such that several capillary tubes 70 run through it. The respective outlets 72 are arranged such that the analyte sample 12 can be supplied into the plasma flux 61 at different positions within the plasma expansion zone 64. The outlet 72 is in contact with the plasma flux 61 such that the outlet 72 is cleaned by the plasma flux 61. The cleaning of the outlet 72 by means of the plasma flux 61 is especially advantageous for liquid analyte samples. For example, the liquid analyte sample may comprise organic, particulate and/or biological matter. The inlet 71 may comprise connecting means configured to connect the capillary tube 70 to a gas chromatograph or a liquid chromatograph or a biological sample introduction system.

In order to introduce the capillary tube 70 into the at least one cone 60, the at least one cone 60 may comprise at least one capillary channel 75 through which the at least one capillary tube 70 is guided. In at least one embodiment, the at least one cone 60 may comprise several capillary channels 75. The at least one cone 60 may be arranged in front of, e.g., upstream of, the extraction electrode 46. The extraction electrode 46 may be configured to generate an ion beam out of the plasma flux 61. As previously mentioned, other positions of the at least one cone 60 are also possible.

Furthermore, a positive or negative voltage may be applied to the at least one cone 60 in order to accelerate positively or negatively charged ionized molecules towards the mass analyzer 50. A voltage source 76 may be used to apply the voltage to the at least one cone 60.

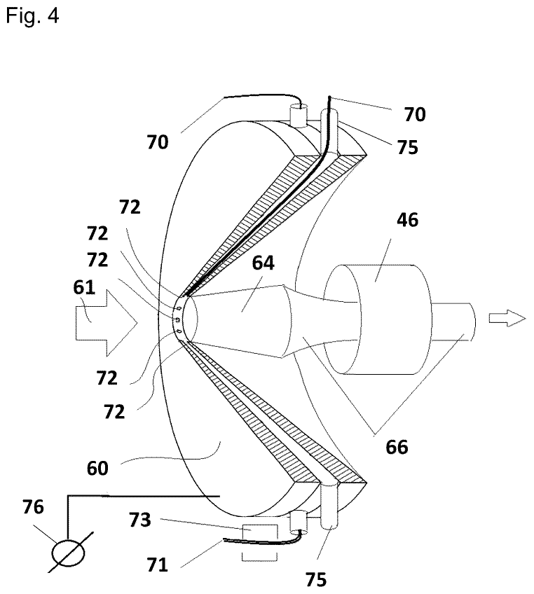

In FIG. 4, a second embodiment of the at least one cone 60 is shown. In the second embodiment, the capillary tubes 70 are arranged within the at least one cone 60 and each outlet 72 is arranged at the orifice 62. In at least one embodiment, the capillary tubes 70 are arranged radially adjacent to each other. For guiding the capillary tubes 70, the at least one cone 60 may comprises at least one capillary channel 75. If several capillary channels 75 are present within the at least one cone 60, the capillary channels 75 may be arranged radially adjacent to each other. The capillary tube 70 may be connectable to a gas chromatograph, a liquid chromatograph, or a biological sample introduction system. A heating element 73 may be arranged next to the capillary tube 70 for heating the analyte sample 12.

1. A mass spectrometer for analyzing an analyte sample, the mass spectrometer comprising:
a plasma ion source configured to generate a plasma;
an interface arrangement configured to form a plasma flux from the plasma and to direct the plasma flux in a flow toward a mass analyzer, wherein the interface arrangement comprises at least one cone and at least one capillary tube,
wherein the at least one cone includes an orifice through which the plasma flux is flowed,
wherein the at least one capillary tube includes an inlet and an outlet and is arranged and configured to introduce the analyte sample into the plasma flux at the orifice or in a plasma expansion zone downstream of the orifice such that the analyte sample is ionized by the plasma flux and ions are thereby generated,
wherein the outlet is in contact with the plasma flux;
the mass analyzer, which is configured to filter and/or separate the generated ions; and
a detector configured to detect the generated ions from the analyte sample.

2. The mass spectrometer according to claim 1, wherein the at least one capillary tube is arranged in a plane parallel to a plane in which the at least one cone is arranged.

3. The mass spectrometer according to claim 1, wherein the at least one cone includes a first cone, and wherein the at least one capillary tube is arranged in a plane parallel to a plane in which the first cone is arranged.

4. The mass spectrometer according to claim 1, wherein the at least one capillary tube includes two or more capillary tubes, and wherein the interface arrangement comprises the two or more capillary tubes.

5. The mass spectrometer according to claim 4, wherein the two or more capillary tubes are arranged radially adjacent to each other.

6. The mass spectrometer according to claim 1, wherein the outlet of the at least one capillary tube is arranged at a distance to the plasma ion source and/or to the at least one cone such that the analyte sample is ionized with a predetermined density of the plasma flux.

7. The mass spectrometer according to claim 1, wherein the at least one capillary tube is arranged within the at least one cone or adjacent thereto.

8. The mass spectrometer according to claim 1, wherein the at least one cone is a skimmer cone, a sampler cone, or a hyper-skimmer cone.

9. The mass spectrometer according to claim 1, wherein the at least one cone is disposed in a vacuum.

10. The mass spectrometer according to claim 1, wherein the at least one cone is arranged adjacent to the plasma ion source.

11. The mass spectrometer according to claim 10, wherein the mass spectrometer comprises a voltage source configured to apply a positive or negative voltage to the at least one cone.

12. The mass spectrometer according to claim 11, wherein the voltage source is configured to adjust the positive and/or negative voltage at the at least one cone between 0 to ±200 V with respect to a potential of the plasma flux.

13. The mass spectrometer according to claim 1, wherein the analyte sample comprises organic, particulate, and/or biological matter.

14. The mass spectrometer according to claim 1, wherein the at least one capillary tube is connectable to a gas chromatograph, a liquid chromatograph, or a biological sample introduction system.

15. The mass spectrometer according to claim 1, wherein the mass spectrometer comprises two or more detectors.

16. The mass spectrometer according to claim 1, wherein the plasma ion source is configured to produce a plasma at atmospheric pressure.
